(19) United States
(12) Patent Application Publication
(10) Pub. No.: US 2026/0350421 A1
(43) Pub. Date: Nov. 5, 2026

(54) CROSS-EFFECT ITEM ESTIMATION TECHNIQUES

(71) Applicant: Oracle International Corporation, Redwood Shores, CA (US)

(72) Inventors: Debdatta Sinha Roy, Boston, MA (US); Rebecca Hsiang-Yun Schubertruegmer, Cambridge, MA (US); Kiran Venkata Panchamgam, Bedford, MA (US); Setareh Borjian, Hamden, CT (US)

(73) Assignee: Oracle International Corporation, Redwood Shores, CA (US)

(21) Appl. No.: 19/569,504

(22) Filed: Mar. 17, 2026

Related U.S. Application Data
(60) Provisional application No. 63/798,390, filed on May 1, 2025.
(60) Provisional application No. 63/815,292, filed on May 30, 2025.

(51) Int. Cl. G06N 5/01; G06F 17/18

(52) U.S. Cl. CPC G06N 5/013; G06F 17/18

(57) ABSTRACT

Techniques for cross-effect estimation of data elements are disclosed. These techniques analyze data relationships through vector representations and embedding spaces. Using a computing system, data elements from multiple groups are transformed into vector representations based on their pairwise relatedness. An embedding space is generated from these vectors, enabling the derivation of cross-effect features for each data element in a pair. These features inform the selection of parameter values for a predictive model, which is subsequently trained using the derived parameters. The model outputs relative cross-effect values for each data element pair, providing insights into their interactions. This approach enhances the understanding of complex relationships between data elements, supporting applications in predictive analytics and decision-making.

### CROSS-REFERENCES TO RELATED APPLICATIONS

This application claims the benefit of and priority to U.S. Provisional Application No. 63/798,390, filed on May 1, 2025 and U.S. Provisional Application No. 63/815,292, filed on May 30, 2025, which are both incorporated by reference in their entirety for all purposes. This application is also related to U.S. Non-Provisional Application No. ______ (ORC25140024-US-NPR (RGIU #2), filed on which is also incorporated by reference in its entirety for all purposes.

### BACKGROUND

Forecasting techniques have evolved over the years with the advancement in machine learning. None of these techniques, however, address the problem of cross-effect estimation. Using time series data for each data element independently is sufficient to capture influences from seasonality but does not capture cross-effects. Thus, forecasting techniques that work well for capturing seasonality and other self-effects fall short when addressing the issue of cross-effects.

### BRIEF SUMMARY

Some aspects of the present disclosure relate to a method for generating cross-effects between data elements. The method can include generating a plurality of vector representations of data elements from a plurality of groups organized based at least in part on relatedness of the pairs of data elements, generating an embedding space using the plurality of vector representations, selecting a set of parameter values for the model based at least in part on the one or more cross-effect features, training the model based at least in part on the set of parameter values and providing an output that identifies a relative cross-effect value for each data element of the pair of data elements according to the model.

In some embodiments, the one or more validation metrics include an embedding space dimension, a group reconstruction score, and a complement/substitute score. In some embodiments, the value of the embedding space dimension is as small as possible while maintaining a probability density function with only two inflection points. In other embodiments, the complement/substitute score is a percentage of substitute and complement pairs of data elements within a threshold number of neighbors of each of the plurality of vector representations within the embedding space.

The group reconstruction score could be a probability of determining a data element if the data element was removed from a group based on the remaining data elements in the group. In some embodiments, the group reconstruction score is calculated by selecting a data element, removing the data element from a first group, and calculating similarity between the group to a second group. The second group may be selected based on proximity between the second group to the first group within the embedding space after the data element has been removed.

Generating the one or more cross-effect features for each data element of a pair of data elements further may include multiplying each pair of data elements with a numerical attribute associated with a data element from each pair of data elements.

In some embodiments, the parameter values for the model are selected using a tree-based validation method.

### BRIEF DESCRIPTION OF THE DRAWINGS

FIG. 1 is a flowchart illustrating the cross-effect estimation technique.

FIG. 2 is a table illustrating one embodiment of training data supplied to the cross-effect estimation technique.

FIG. 3 is pseudocode illustrating the process for training the vector embedding space.

FIG. 4 is a set of graphs illustrating one embodiment of the distributions for pairwise dot products of embedding spaces with different dimensions.

FIG. 5 is a table illustrating one embodiment of features used to define a forecasting model.

FIG. 6 is a block diagram illustrating one embodiment of data manipulation across the cross-effect estimation technique.

FIG. 7 is a flowchart illustrating one embodiment for a model simplification method.

FIG. 8 is a block diagram illustrating one embodiment where parameter values are selected by a tree-based validation method.

FIG. 9 is a flowchart illustrating one embodiment of the cross-effect estimation technique.

FIG. 10 is a flowchart illustrating one embodiment for iterative feedback techniques.

FIG. 11 is a block diagram illustrating another pattern for implementing a cloud infrastructure as a service system, according to at least one embodiment.

In the appended figures, similar components and/or features may have the same reference label. Where the reference label is used in the specification, the description is applicable to any one of the similar components having the same reference label.

### DETAILED DESCRIPTION

The ensuing description provides illustrative embodiment(s) only and is not intended to limit the scope, applicability or configuration of the disclosure. Rather, the ensuing description of the illustrative embodiment(s) will provide those skilled in the art with an enabling description for implementing a preferred exemplary embodiment. It is understood that various changes can be made in the function and arrangement of elements without departing from the spirit and scope as set forth in the appended claims.

Forecasting is a vital part of data prediction: it impacts many aspects of strategy, allowing businesses and individuals to anticipate future outcomes, enabling better decision-making, resource allocation, and strategic planning. By analyzing historical data and identifying patterns, forecasting provides insights into potential risks and opportunities, allowing for proactive measures to be taken. This leads to improved efficiency, reduced costs, and ultimately, increased profitability. The values assigned to a data element, however, impact not only its own relative importance but also impact the importance of other data elements (called cross elasticity or cross effects). One major challenge is the accurate understanding of cross effects and, therefore, performing value forecasting considering the cross effects.

There are two types of data element pairs where cross effects are observed: complementary and substitution pairs. Complementary data element pairs often occur together, so the occurrences for both data pairs move in the same direction. When the occurrence of one data element increases, so does the occurrence of the other. Substitution data element pairs are in competition with each other, so occurrences of the two data elements move in the opposite direction. When occurrences of one data element increase, this decreases occurrences for the other.

Data strategists face an increasingly complex challenge in understanding the relationships between data elements, especially in scenarios with a large number of data elements (and thus a large number of pairs of data elements). Each pair of data elements can be classified as a complement, a substitute, or unrelated to accurately predict how changes in the attributes of one data element impact the occurrences of another. However, existing forecasting processes fail to address this critical decision, and manually classifying these pairs is impractical due to the sheer volume of data.

To circumvent this issue, data strategists typically group data elements based on their attributes and apply generic assumptions about their relationships. The process of adding attributes to data elements is often manual, however, and is time intensive and prone to inaccuracies due to manual errors in assigning attributes, bias in selecting relevant attributes, and the exclusion of critical information. Further, drastic pattern shifts in many facets of life since the onset of COVID-19 make static assumptions about relationships between data elements obsolete. Seasonal changes may also impact cross-effect relationships, further complicating forecasting.

While advancements in machine learning have improved forecasting techniques, these models typically focus on individual data elements and fail to capture the cross-effects between data elements. As a result, these techniques are effective at predicting seasonality and self-altering effects but fall short in addressing the dynamic interactions between data element pairs.

The details described here introduce novel cross-effect estimation techniques that provide a two-part framework to classify data element pairs as substitutes, complements, or unrelated and incorporates these relationships into forecasting models. The techniques take group-level data as input and outputs cross-effect features that can be seamlessly integrated into any existing forecasting process to enhance accuracy.

This new technique addresses critical gaps in forecasting by introducing a machine-learning-based framework that captures dynamic interactions between data element pairs by grouping data elements together based purely on group data. A trained embedding space is then validated for accuracy and improved with a feedback process. Finally, the information learned from the embedding space is used to build features for the estimation of cross effects. As a result, a manageable number of data element pairs that show significant cross effects (either complementary or substitution) are selected for forecasting models. This technique equips data strategists with the tools to adapt to rapidly changing trends and evolving conditions, ultimately driving improved accuracy in forecasting and enabling better decisions.

The cross-effect estimation techniques enable the dynamic classification of data element pairs because cross-effect relationships are updated over time. Further, the techniques increase forecasting accuracy by incorporating cross-effect features into forecasting models, thereby improving predictions and enabling strategists to make informed decisions. The techniques are also adaptable because metrics and feature designs are flexible, allowing customization to specific business needs and seasonal requirements. This technique further reduces human bias because automated processes minimize errors and biases inherent in manual attribute-based grouping methods.

The techniques are also scalable as this technique ensures computational efficiency, accommodating large datasets. The process of generating cross-effect features leverages the learned embedding space to significantly reduce computational complexity: instead of estimating coefficients for every pairwise combination of data elements, the techniques estimate a single coefficient for each data element, capturing its cross-effect on all other data elements. This simplification reduces the computational burden from O(n²) for n data elements to O(n). Additionally, two thresholds are applied to further optimize feature generation: a similarity threshold ensures data elements with a similarity below a configurable cutoff are excluded from cross-effect estimation. Also, only the k-nearest neighbors (e.g., 3 to 5) are considered for cross-effect generation, ensuring interpretability and scalability.

These cross-effect estimation techniques may be implemented in various settings by leveraging group-level data from point-of-sale systems and integrating seamlessly with existing forecasting techniques. The embedding space training and cross-effect estimation processes are designed to scale efficiently, ensuring applicability to diverse environments.

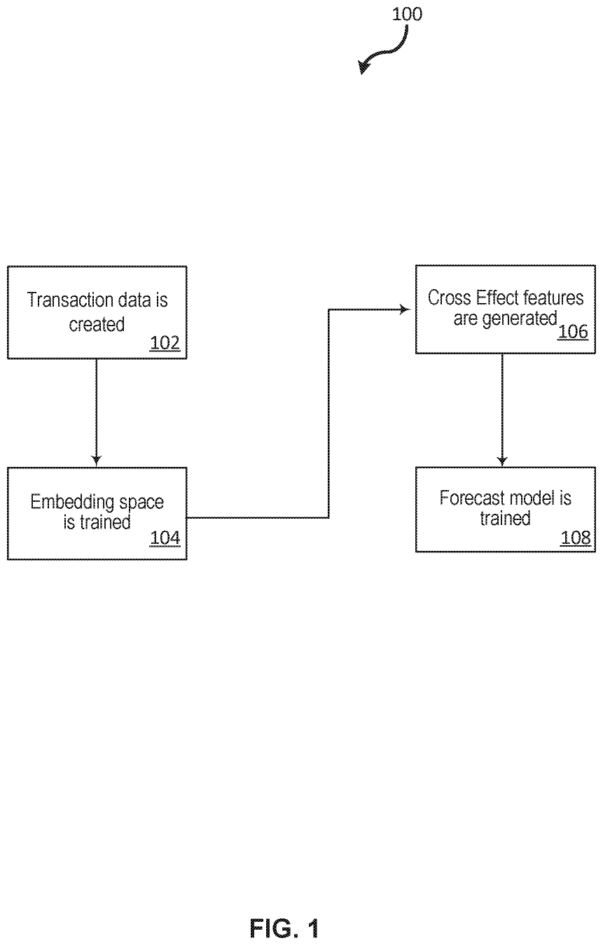

With reference now to FIG. 1, a flowchart illustrating the cross-effect estimation technique 100 is shown. The first part of the technique (102 and 104) concerns training an embedding space that all data elements are mapped into, including (1) a data preparation process 102 that creates pairs of data elements that were bought or not bought together based on the groups and (2) a training process 104 that creates the embedding space. The second part of the technique (106 and 108) concerns cross effect estimation using the embedding space, including (1) generating cross effect specific features 106 and (2) training the forecasting model 108. At the end, this framework identifies the relevant cross effect estimations for each data element.

The first part of the technique includes training the embedding space. This part of the technique creates a vector representation for each data element in an embedding space, enabling the classification of data element pairs based on their relationships.

First, pairs of data elements are generated based on group data (102). The training process of the embedding space relies on the creation of positive and negative samples derived from group data.

Positive samples are defined as pairs of data elements that occur together in the same group. For each group containing k data elements, all possible combinations of data element pairs are generated as positive samples, resulting in (k²) rows labeled with a positive value (label 1). For example, if data elements A, B, and C appear together in a group, the positive samples would include pairs (A, B), (B, C), and (A, C).

Negative samples, on the other hand, are formed by pairing a data element that appeared in the group with a data element that did not appear in the group. The negative sampling process employs an empirical distribution of all data elements across all groups, referred to as the unigram distribution, raised to the power of 0.75. This smoothing exponent overemphasizes data elements that occur in fewer groups and underemphasizes data elements that occur with higher group frequencies. For each group containing k data elements, j×k rows are generated as negative samples (label 0), where j is a configurable parameter representing the number of negative samples per data element (default value: j=1). Negative sampling ensures the representation of the entire group data and impacts the quality of the embedding space. This sampling approach ensures computational efficiency while capturing the complementary and substitution effects between data elements.

The embedding space is then trained. One such way of training the embedding space is using the “Item2Vec” algorithm (104). The new “Item2Vec” algorithmic framework can represent data elements as vectors in an n-dimensional embedding space. This is motivated from an established method called “Word2Vec” which is usually used within the domain of natural language processing (NLP) that can represent words in a vector space. Item2Vec iteratively moves data element pairs with positive labels closer together in the embedding space while distancing pairs with negative labels. This approach is computationally efficient and scalable, accommodating a large volume of data element pairs and groups.

After the embedding space is trained, cross-effect features are generated (106). Cross-effect features are designed to capture the influence of attributes of one data element on another data element's occurrences. In some embodiments, the similarity between data elements (derived from their vector representations) is multiplied by a value associated with one data element to create a feature for the forecasting model of the other data element. Simplifications reduce computational complexity, such as estimating a single coefficient for each data element to capture cross-effects on all other data elements and limiting features to the k-nearest neighbors with a similarity above a threshold. Complement and substitute effects can be differentiated by applying a multiplier of −1 to one of the effects.

Linear regression techniques can then train the forecasting model on the prepared dataset (108). Linear regression is a foundational statistical technique widely used in data analysis and predictive modeling. It establishes a relationship between a dependent variable and one or more independent variables by fitting a linear equation to the observed data. The simplest form, known as simple linear regression, involves a single independent variable, while multiple linear regression extends the approach to include two or more independent variables. The goal of linear regression is to minimize the difference between the observed values and the predicted values, typically by using the method of least squares to find the best-fitting line or plane.

Linear regression assumes a linear relationship between the dependent and independent variables, meaning that changes in the independent variables lead to proportional changes in the dependent variable. It is particularly useful for predicting outcomes, evaluating trends, and identifying the strength of relationships between variables. The model outputs coefficients that represent the impact of each independent variable on the dependent variable, allowing for interpretation and decision-making in various fields such as finance, healthcare, marketing, and engineering.

Here, the training process involves splitting the dataset into training and validation subsets. Regression techniques are applied to the training subset to fit the model parameters, while the validation subset is used to evaluate performance metrics such as Weighted Mean Absolute Percentage Error (WMAPE). Linear regression techniques that work well in cross-effect estimation technique 100 include Lasso and Ridge regression techniques.

Lasso regression, also known as Least Absolute Shrinkage and Selection Operator regression, is a linear modeling technique that incorporates an L1 regularization term in the objective function. Lasso regression is used to select the most critical features by eliminating irrelevant or weakly correlated variables. For example, it might exclude features associated with distant neighbors in the embedding space that have minimal influence on the target data element. The L1 regularization term shrinks coefficients toward zero, effectively performing feature selection by eliminating irrelevant or redundant features from the model. In the context of forecast modeling, Lasso regression is particularly useful for identifying the most significant features, such as cross-effect relationships, price elasticity, and seasonality factors, while excluding less relevant variables.

Ridge regression, also known as Tikhonov regularization, is a linear modeling technique that incorporates an L2 regularization term in the objective function. Ridge regression is used to handle scenarios where features are highly correlated, such as cross-effect features derived from similar data elements in the embedding space. By distributing weights across correlated features, Ridge regression ensures stability and avoids overfitting. The L2 regularization term prevents overfitting by shrinking the coefficients but does not eliminate features completely. Ridge regression is particularly useful in scenarios where features are highly collinear, ensuring stability in the model's predictions by distributing weights among correlated features.

In some embodiments, a hybrid approach combining Lasso and Ridge regression may be employed, referred to as Elastic Net regression. Elastic Net incorporates both L1 and L2 regularization terms, enabling simultaneous feature selection and weight distribution across correlated features. Elastic Net is particularly effective in scenarios where the dataset contains both sparse and highly correlated features.

These regression methods are employed to optimize the parameters of the forecast model, ensuring efficient feature selection and avoiding overfitting in scenarios involving complex datasets with numerous features. Parameters such as k-nearest neighbors, similarity thresholds, and regularization values can be optimized using validation data.

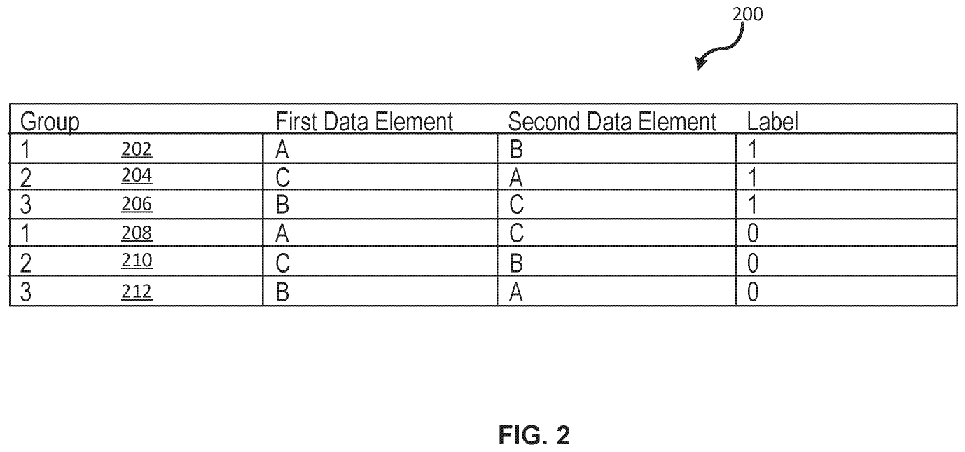

With reference now to FIG. 2, a table illustrating one embodiment of training data supplied to the cross-effect estimation technique is shown. In table 200, each group (1-3) contains a pair of data elements (A, B, or C). The table contains combinations of pairs of data elements accompanied by a label indicating whether the data elements appeared together in a given group.

In this example, raw data is transformed into positive and negative samples used for the training process of the embedding space. The resulting table contains data element pairs as rows, together with a label of whether the data element pair constitutes a positive or a negative sample.

The process of positive sampling for a group is straightforward, as the data elements that appear together can be directly observed. Positive samples are formed by taking all possible combinations of data element pairs within a group. For each group that has k data elements, there are (k²) rows with positive label (label 1).

The process of negative sampling involves a selection of a data element that does not appear in the group. The exact process of determining that data element from outside the group has a significant impact on the training process and the final quality of the embedding space and can make training the embedding space faster and more efficient.

As mentioned above, negative samples can be formed by taking a data element that appeared in the group and pairing it with a sampled data element that did not appear in the group. The underlying sampling distribution is the empirical distribution of all data elements across all groups, sometimes also referred to as the unigram distribution in the NLP world, raised to the power of 0.75. The exponent of 0.75 has a smoothing effect, overemphasizing data elements that appeared in few groups, and underemphasizing data elements that appeared in many groups. For each group that has k data elements, there are j*k rows with negative label (label 0), where j is a configurable parameter that sets the number of negative samples per data element in a group (default value for j is 1).

Table 200 thus represents one embodiment that illustrates how the training data is generated in the way explained above. Suppose three groups 1, 2, and 3, involve three data elements (A, B, and C). Group 1 202/208 has data elements A and B, group 2 204/210 has data elements A and C, and group 3 206/212 has data elements B and C. In this example, j=0.5. Because data elements A and B appear together in group 1, this is denoted with label 1 in row 202; because data elements A and C do not appear together in group 1, this is denoted with label 0 in row 208. Because data elements C and A appear together in group 2, this is denoted with label 1 in row 204; because data elements C and B do not appear together in group 2, this is denoted with label 0 in row 210. Because data elements B and C appear together in group 3, this is denoted with label 1 in row 206; because data elements B and A do not appear together in group 3, this is denoted with label 0 in 212.

Consider one example, a retail setting where the data elements are items that are sold together. If items A and B are complements, they often appear together in a transaction (i.e., bread and butter). On the other hand, if items A and C are substitutes, they rarely appear together, such as different brands of cereal. Being able to incorporate this information in a forecasting model makes predictions more accurate, especially in dynamic real-life settings.

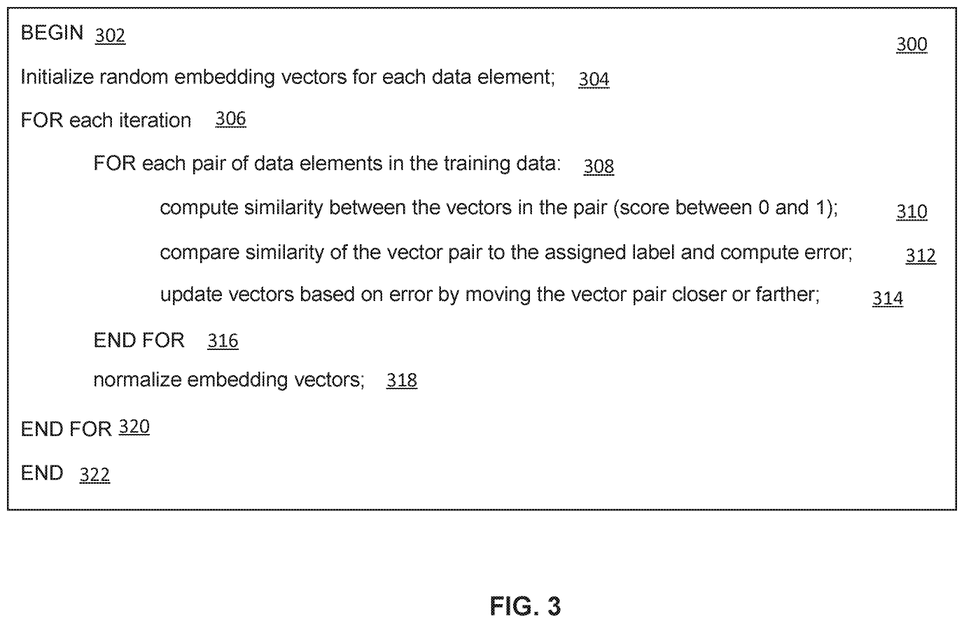

With reference now to FIG. 3, pseudocode illustrating one embodiment of a process for training the vector embedding space is shown. This process, “Item2Vec” has many similarities to the “Word2Vec” process from natural language processing (NLP) and machine learning. Word2Vec generates vector representations of words in a multi-dimensional space to capture semantic and syntactic relationships between words for computational applications. Word2Vec maintains the ability to computationally represent words in a manner that captures their meanings and relationships by generating an embedding space where similar words are mapped closer to one another based on their contextual usage in a corpus. Similarly, Item2Vec maintains the ability to computationally represent data elements (such as items purchased together in a transaction) in a manner that captures their meanings and relationships. Item2Vec is designed to iteratively adjust embedding vectors associated with data elements to optimize their spatial relationships within the embedding space based on their assigned labels, similarity, or other attributes. In most embodiments, pairs of data elements with positive labels are moved closer together, while those with negative labels are moved farther apart.

The process begins at line 302, where the technique initializes its operations. At line 304, random embedding vectors are generated for each data element in the training dataset. These random vectors serve as the initial positions of the data elements within the embedding space.

Following initialization, the technique enters a first iterative loop at line 306, which executes for a predefined number of iterations. This loop is structured to refine the embedding vectors progressively over time. Within the first loop, a nested second loop commences at line 308, iterating over all pairs of data elements in the training data. For each pair of data elements processed within the nested loop, the technique calculates a similarity score at line 310. This score is a numerical value ranging between 0 and 1, representing the degree of similarity between the embedding vectors of the pair.

Once the similarity score is computed, the technique proceeds to line 312, where the similarity score is compared with the pair's assigned label (indicating whether the pair should be considered similar or dissimilar). An error is then computed based on this comparison. The error quantifies the deviation between the calculated similarity score and the expected similarity as indicated by the label.

At line 314, the embedding vectors for the pair are updated based on the computed error. Specifically, if the error indicates that the pair should be closer together in the embedding space, their vectors are adjusted to reduce the distance between them. Conversely, if the error indicates that the pair should be farther apart, their vectors are adjusted to increase the distance between them.

Once the vectors are updated, the processes within the nested loop conclude at line 316, and the technique proceeds to the next pair of data elements. After all pairs have been processed within the nested loop, the technique normalizes the embedding vectors at line 318. Normalization ensures that the vectors maintain consistent magnitudes and conform to constraints required by the embedding space.

In another embodiment, the quality of the embedding space is further validated through a basket reconstruction score. This score quantifies how accurately the system can identify an item that was removed from a transaction basket, using only the embedding vectors of the remaining items. For each transaction, the system iteratively removes one item and computes the similarity between the removed item and each remaining item based on their vector representations. The highest similarity value is recorded as the reconstruction score for that item. This process is repeated for all items across all baskets, and the aggregate scores provide a direct measure of the embedding space's ability to capture co-occurrence relationships. A high basket reconstruction score indicates that the embedding vectors are effectively encoding the latent structure of item groupings, which is critical for robust cross-effect estimation.

The basket reconstruction score serves not only as a diagnostic tool but also informs subsequent feedback mechanisms to refine the embedding space. Samples that are more difficult to reconstruct are weighted more heavily during retraining, ensuring that the embedding space continually improves in its ability to represent meaningful item relationships.

In some embodiments, the quality of the trained embedding space is enhanced through a multi-faceted feedback process that iteratively refines the underlying vector representations. This process comprises three distinct feedback mechanisms: (1) basket reconstruction feedback, wherein the weights of positive training samples are dynamically adjusted based on the difficulty of reconstructing removed items from transaction baskets; (2) substitute feedback, which introduces explicit positive samples for item pairs identified as substitutes, ensuring that substitute relationships are adequately captured despite their infrequent co-occurrence; and (3) non-complement/non-substitute negative feedback, which generates additional negative samples for item pairs that are neither complements nor substitutes, thereby increasing the discrimination power of the embedding space. The feedback process leverages validation metrics to select samples for reweighting or augmentation, with the goal of optimizing the embedding space for downstream tasks such as cross-effect estimation and demand modeling. This iterative refinement ensures that the embedding space remains robust and accurately reflects dynamic item relationships, including those that evolve over time or in response to business-specific definitions of complements and substitutes.

Additionally, to maintain statistical balance, the system reweights all negative samples so that the aggregate weight matches that of the positive samples. This normalization step prevents bias arising from disproportionate sample weighting during retraining and ensures consistent model quality across iterations.

After each feedback iteration, the system recalibrates the weights of negative training samples to ensure that the total weight of negative samples matches that of the positive samples. This reweighting step is essential for maintaining statistical parity between sample types, preventing the model from becoming biased toward over-represented classes, and promoting stable convergence during retraining. The system automatically computes the aggregate weights following feedback adjustments and applies uniform scaling to the negative samples, thereby preserving model accuracy and integrity across iterations.

The first iterative loop ends at line 320 after the prescribed number of iterations have been completed. Finally, the technique concludes its operations at line 322.

The iterative nature of technique 300 enables the embedding space to converge toward an optimal configuration, wherein the spatial arrangement of embedding vectors accurately reflects the relationships indicated by the training data labels. This process creates a high-quality embedding space for downstream tasks such as classification, clustering, or similarity-based retrieval. Further, training the embedding space in this way makes it possible to capture the effects of both complements and substitutes, which is something that any attribute-based method cannot.

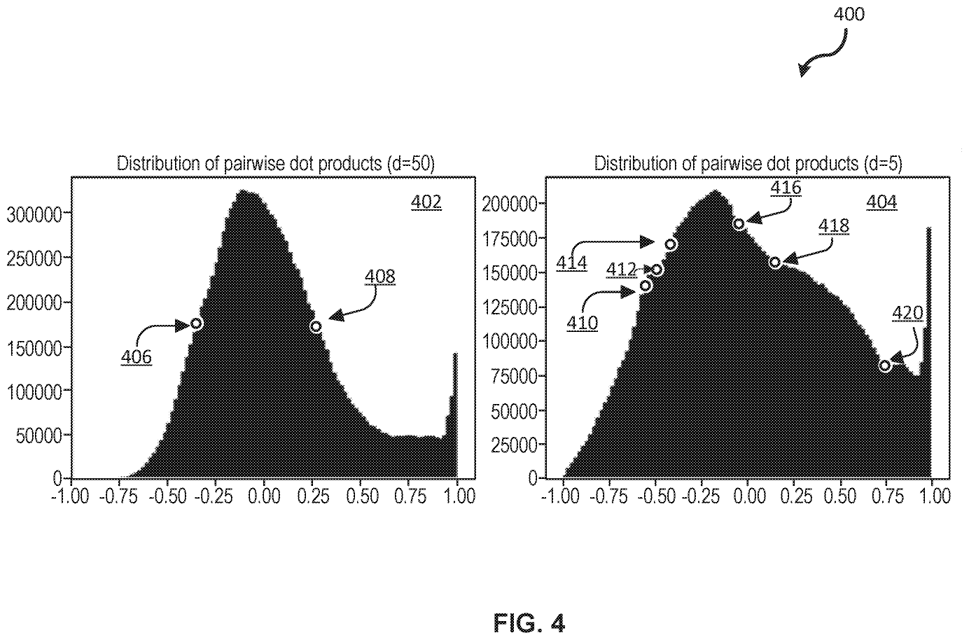

With reference now to FIG. 4, a set of graphs illustrating one embodiment of the distributions for pairwise dot products of embedding spaces with different dimensions is shown. The graphs serve to highlight a method for selecting the optimal dimension for an embedding space, which can serve as one validation metric in the training process. This method balances the tradeoff between capturing complex relationships with large-dimensional embeddings and maintaining computational efficiency with smaller dimensions.

The choice of embedding space dimension is guided by analyzing the probability density function (PDF) of the pairwise dot products of vector representations of all data elements in the embedding space. The underlying principle is that if the embedding space has sufficient dimensionality to allow meaningful movement of data elements during training, the distribution of pairwise dot products will approximate a bell curve. This curve is expected to peak at 1 because complementary and substitution data elements are deliberately moved closer together during training.

In some embodiments, the dimensionality of the embedding space is not selected arbitrarily, but rather through a novel data-driven approach that analyzes the probability density function (PDF) of the pairwise dot products of vector representations for all items. Specifically, the embedding space is incrementally trained using varying dimensions, and for each candidate dimension, the PDF of the pairwise dot products is computed. The optimal dimension is selected as the smallest value for which the PDF exhibits exactly two inflection points, corresponding to a bell-shaped curve with a distinct peak at or near unity. This approach ensures that the embedding space is sufficiently expressive to capture complex relationships among items while avoiding unnecessary computational overhead. By leveraging this inflection point analysis, the system dynamically tunes the embedding space to balance representational power and model efficiency, a technical improvement over conventional heuristic-based dimension selection methods.

The use of inflection point analysis in embedding dimension selection is particularly advantageous in large-scale retail settings, where computational resources are at a premium and model complexity must be tightly managed. This technique allows for automatic, objective determination of the appropriate embedding space dimensionality, which directly impacts the fidelity of item relationship modeling and downstream forecasting accuracy.

In some embodiments, the system further evaluates the embedding space using a complement/substitute score, which measures the fraction of known complement and substitute pairs within the k-nearest neighbors of each item vector. Complements are defined as items that appear together in transactions with a frequency exceeding a configurable threshold (e.g., 90%), while substitutes are items that rarely co-occur but share common complements. The complement/substitute score is computed as the average percentage of complements and substitutes among the nearest neighbors for all items, with additional balancing to avoid bias toward either relationship type. This metric ensures that the embedding space is not only accurate but also balanced in representing both complementary and substitution effects, which is essential for downstream demand modeling.

The set of graphs 400 illustrates the distributions for two embedding spaces trained with different dimensions. Graph 402 represents an embedding space with a dimension of 50, while the graph 404 corresponds to an embedding space with a dimension of 5. The distributions are analyzed by counting the number of inflection points in the PDF of pairwise dot products, where an inflection point is defined as a point on the curve where the curvature changes direction.

In the larger-dimensional embedding space 402, the PDF exhibits two inflection points, labeled as 406 and 408. This distribution demonstrates the desired bell curve structure, with a peak at 1, indicating sufficient dimensionality to capture the relationships among data elements in the embedding space.

In contrast, the smaller-dimensional embedding space 404 exhibits six inflection points, labeled as 410, 412, 414, 416, 418, and 420. The presence of multiple inflection points suggests that the embedding space lacks sufficient dimensionality to achieve the desired bell curve structure. Instead, the distribution is fragmented, indicating that the space does not adequately capture the complexity of relationships among data elements.

To determine the optimal dimensionality for the embedding space, the method selects the smallest dimension that results in a PDF with exactly two inflection points. This ensures that the embedding space is sufficiently large to capture the necessary information while minimizing computational overhead. Thus, the embedding space with a dimension of 50 would be deemed optimal for this embodiment, as it is the smallest dimension where the PDF exhibits the desired two inflection points.

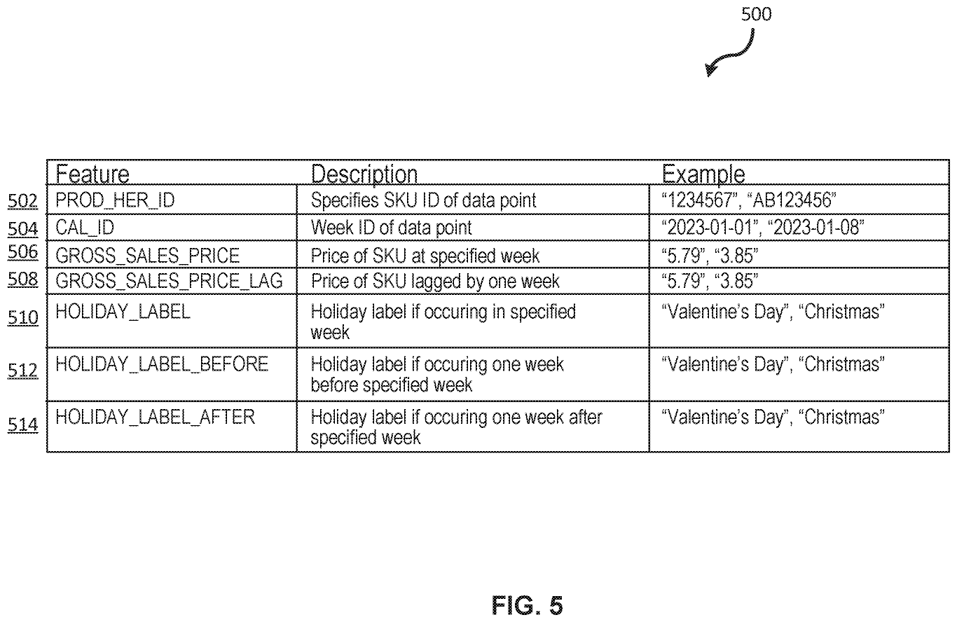

With reference now to FIG. 5, a table illustrating one embodiment of features used to define a forecast model is shown. This embodiment can leverage aggregated group data to estimate demand across various data elements, here referred to as “SKUs,” within a specified product hierarchy level. The aggregation levels for this data can be configured based on business needs, with the final data aggregated at the week level and at a defined location hierarchy level. The SKU-level data is preserved throughout this process to ensure that embedding information remains tied to individual SKUs. Forecast estimation is performed simultaneously for all SKUs within a specific product hierarchy level, which may be lower than the hierarchy level used during the training of the embedding space.

The baseline forecast model, which excludes cross-effects, utilizes a flexible set of features that can be adapted according to specific business requirements. Table 500 organizes these features under three headings: Feature, Description, and Example.

The features and their corresponding rows in the table are described as follows: Row 502 contains a feature labeled “Product Hierarchy ID” that specifies the unique identifier for the SKU associated with the data point. Examples of SKU identifiers include “1234567” and “AB123456”. Row 504 contains a feature labeled “Calendar ID” that represents the week identifier for the data point; this feature captures the time dimension at the aggregated week level. Examples of week identifiers include “2023 Jan. 1” and “2023 Jan. 8”. Row 506 contains a feature labeled “Gross Sales Price” that denotes the gross sales price of the SKU during the specified week; this feature captures the pricing information that influences demand. Examples of gross sales prices include “5.79” and “3.85”. Row 508 contains a feature labeled “Gross Sales Price Lag” that reflects the gross sales price of the SKU lagged by one week, allowing the model to account for temporal price effects. Examples of lagged gross sales prices include “5.79” and “3.85”. Row 510 contains a feature labeled “Holiday Label” that identifies any holiday occurring during the specified week; this feature captures seasonal demand fluctuations tied to holidays. Row 512 contains a feature labeled “Holiday Label Before” that identifies any holiday occurring one week before the specified week; this feature accounts for pre-holiday effects on demand. Row 514 contains a feature labeled “Holiday Label After” that identifies any holiday occurring one week after the specified week; this feature accounts for post-holiday effects on demand. Examples of holiday labels for Holiday Label 510, Holiday Label Before 512, and Holiday Label After 514 include “Valentine's Day” and “Christmas”.

The features outlined in table 500 provide a comprehensive framework for modeling demand by incorporating SKU-level data, temporal factors, pricing information, and holiday-related effects. The flexibility of this approach allows for adaptation to various scenarios, enabling the forecast model to align with specific objectives. By leveraging the features described in table 500, the forecast model can facilitate accurate and scalable estimation of demand across diverse product hierarchies and timeframes.

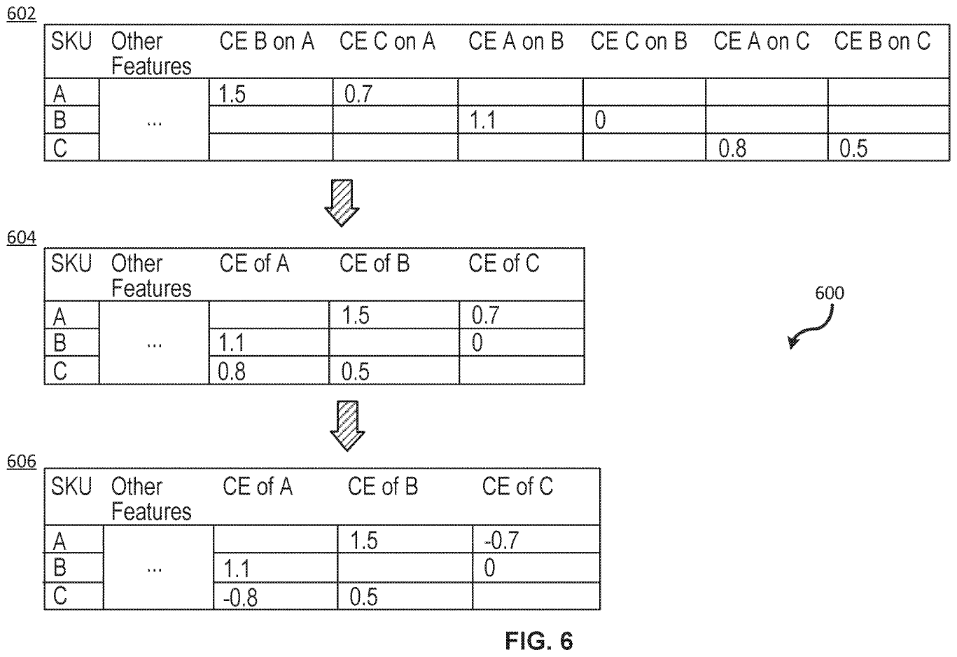

With reference now to FIG. 6, a block diagram illustrating one embodiment of data manipulation across the cross-effect estimation technique. This process results in output 606, which identifies the cross-effects for each data element by leveraging the learned embedding space and cross-effect features.

The process begins with cross-effect features 602, which capture relationships between data elements, such as complementary and substitution effects. These features are enhanced using information derived from the learned embedding space.

To model the cross-effect of data element B on data element A, the cross-effect feature is computed as the product of the cosine similarity between data element A and data element B's embedding vectors, denoted as VA. VB, and the relevant variable associated with data element B. This method leverages the embedding space to significantly reduce computational complexity, as generating features for all possible pairs of data elements in a universe of n data elements would require processing

$$( \frac{n}{2} )$$

pairs—a computationally prohibitive task for large datasets.

To address this challenge, the method limits the number of cross-effect features estimated to k per data element, where k is a configurable parameter. Typically, k is kept small (e.g., between 3 and 5) to balance computational efficiency with interpretability. For each data element, the k-nearest data elements in the embedding space are identified based on cosine similarity, and these data elements are used to form cross-effect features. This reduction in feature generation scope significantly simplifies the scale of the problem while maintaining meaningful cross-effect relationships.

To further streamline cross-effect feature generation, the system applies a similarity threshold in the selection of k-nearest neighbors within the embedding space. For each item, only those neighbors whose embedding similarity exceeds a configurable cutoff are included in the cross-effect feature set. This ensures that only the most relevant and influential relationships are considered for demand modeling, reducing noise and computational complexity. The combination of similarity thresholding and k-nearest neighbor selection provides a principled mechanism for feature generation, balancing model accuracy with efficiency.

To further streamline the feature generation process, instead of constructing features for every possible pair (e.g., cross-effect of data element C on data element A; cross-effect of data element C on data element B, etc.), a single feature is built for each data element to represent the aggregate cross-effects exerted by a specific data element on all other data elements. This representation is illustrated in 604 and provides a compact yet informative summary of cross-effects for each data element.

In some embodiments, the system implements a novel approach to model simplification by reducing the number of cross-effect feature coefficients in the regression model. Traditionally, modeling cross-effects among n items requires estimating coefficients for every possible pair, resulting in a quadratic number of parameters. To overcome the computational burden and risk of overfitting, the present technique leverages the learned embedding space to identify a limited set of k-nearest neighbors for each item and aggregates cross-effect features such that a single coefficient is estimated for each item. This reduction transforms the parameter space from O(n²) to O(n), dramatically improving scalability and interpretability without compromising forecasting accuracy.

The coefficient reduction approach is particularly beneficial in large-scale retail environments, where millions or billions of item pairs would otherwise need to be modeled. By focusing on significant cross-effect relationships, the system retains predictive power while enabling practical deployment in real-world settings.

In further embodiments, the system significantly reduces the computational complexity of the cross-effect estimation model by transforming the parameter space from quadratic to linear scale. Traditionally, modeling cross-effects among n items requires estimating coefficients for every possible pairwise combination, resulting in O(n²) parameters. The present technique leverages the learned embedding space to identify k-nearest neighbors for each item and aggregates cross-effect features such that a single coefficient is estimated for each item, reducing the parameter space to O(n). This approach maintains predictive power while dramatically improving scalability, interpretability, and resistance to overfitting. The model further distinguishes between complement and substitute effects by explicitly encoding the sign of the relationship-negative for substitutes and positive for complements-based on prior classification derived from the embedding space or configurable business rules.

The method further distinguishes between the effects of complements and substitutes in the forecast model. Complementary data elements are positively correlated (e.g., an increase in one data element is accompanied by an increase in the other), while substitute data elements exhibit a negative correlation (e.g., an increase in one data element is accompanied by a decrease in the other). To account for these opposing dynamics, the data entries in the built cross-effect features are modified to reflect opposite signs for complements and substitutes. For example, if data element A and data element B are complements, and data element A and data element C are substitutes, the cross-effect of data element C on data element A is adjusted to reflect a negative relationship, while the cross-effect of data element B on data element A reflects a positive relationship. This ensures that the forecast model accurately captures the interplay between complementary and substitution effects. Suppose that A and B are complements, B and C are also complements, but A and C are substitutes. The resulting cross-effects for each data element are captured in output 606.

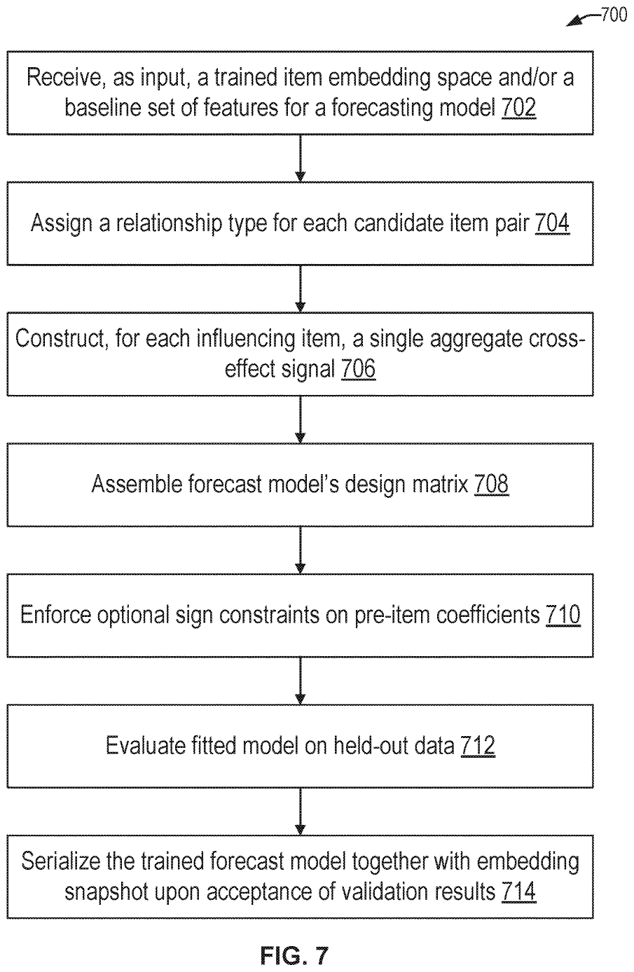

FIG. 7 illustrates a method 700 for model simplification by reducing cross-effect coefficients, among other things. In some examples, the method 700 begins at block 702, where a device receives as input a trained item embedding space and a baseline set of features for a forecasting model, including temporal identifiers, pricing information with optional lags, and holiday indicators, and computes cosine similarities among items to support cross-effect construction with k-nearest-neighbor filtering and a similarity threshold that excludes weakly related items from further consideration, thereby constraining the feature generation scope for both computational efficiency and interpretability of the resulting cross-effect features in the forecast model design matrix at training time and inference time alike.

In some examples, at block 704, the device assigns a relationship type for each candidate item pair in the k-nearest neighborhood of each item by applying either automatic classification based on co-occurrence patterns and shared complements or configurable business rules, and encodes the relationship as a signed effect, using a positive sign for complements and a negative sign for substitutes, so that cross-effect signals that flow into the forecast model directly reflect whether an influencing item's increase is expected to drive up or drive down the target item's demand under the observed embedding relationships and rules definitions active at model build time and deployment time, respectively, for consistent semantics across the pipeline and across environments in production rollout scenarios.

In some examples, at block 706, the device constructs, for each influencing item, a single aggregate cross-effect signal that summarizes that item's impact on all other items by computing a weighted combination of the influencing item's relevant driver variables such as price or promotion multiplied by the cosine similarity to each target item and multiplied by the sign indicator for complement or substitute, thereby producing one scalar feature per influencing item that is reused across all targets and that captures the magnitude and direction of influence while eliminating the need to form a separate parameter for each item-pair combination that would otherwise scale quadratically in the number of items in the universe of interest during model training and deployment operations at retail or other scales of application.

In some examples, at block 708, the device assembles the forecast model's design matrix by concatenating baseline features with one column per influencing item's aggregate cross-effect signal, and estimates a single coefficient per influencing item that is shared across all target items so that parameter count scales linearly with the number of items rather than quadratically with the number of item pairs, and the model is trained using linear regression with L1, L2, or elastic net regularization to maintain stability in the presence of correlated signals across similar items while allowing sparsity to naturally suppress weak influences and enhance interpretability of retained coefficients for decision support in pricing, assortment, or inventory use cases in which the operational stakeholders benefit from a compact explanation of cross-effects discovered by the system at scale.

In some examples, at block 710, the device enforces optional sign constraints on the per-item coefficients that align with the predetermined complement or substitute classification to further stabilize estimation and to ensure that substitute relationships carry negative coefficients while complement relationships carry positive coefficients, even as the embedding space and neighbor graph evolve over time in response to updated feedback-driven training and rules adjustments, thereby ensuring coherence between the structural encoding of relationships and the parameter semantics in the downstream forecast model for production-grade robustness and governance auditing of model behavior under drift conditions or seasonality shifts in the underlying data streams.

In some examples, at block 712, the device evaluates the fitted model on held-out data using weighted mean absolute percentage error or other configurable business-aligned metrics and, if necessary, revisits similarity thresholds, neighbor counts, and regularization strengths through a robust validation process that favors parameter sets with strong mean payoffs and that avoid proximity to outlier scores, thereby improving generalization to new data while preserving the linear parameter scaling benefits of the single-coefficient-per-item structure and maintaining the interpretability of the model's cross-effect representation relative to larger and more complex pairwise coefficient matrices that would be unwieldy to deploy and maintain operationally at scale in production environments with millions of items and billions of potential item pairs considered in aggregate over time horizons of interest for planning exercises and automated decision loops.

In some examples, at block 714, upon acceptance of validation results, the device serializes the trained forecast model together with the embedding snapshot, neighbor index, similarity threshold, and rules configuration so that future inference requests and periodic retraining can reproduce the same cross-effect signal construction deterministically, and the system thereby separates the representation layer from the estimation layer, enabling incremental updates to embeddings via the feedback process without requiring redesign of the cross-effect feature schema, and preserving the linear parameterization property that permits efficient model refresh cycles and scalable batch or streaming inference under operational constraints common to large-scale analytic systems deployed in commercial settings with heterogeneous compute and storage infrastructure topologies to be accommodated by the implementation's modular architecture and standard data interchange formats used in the pipeline orchestration environment for repeatable production-grade performance guarantees and reliability service-level objectives.

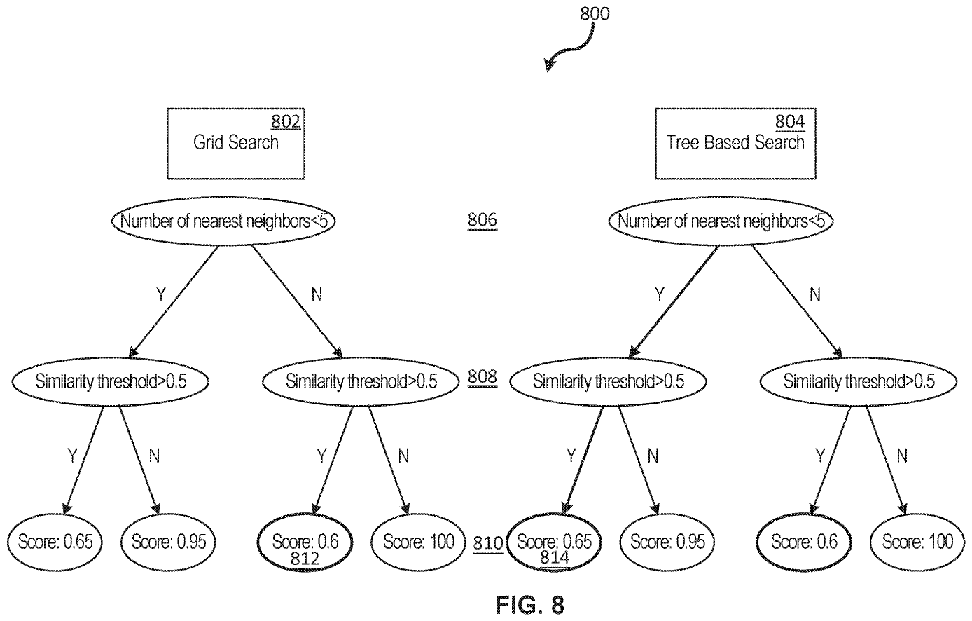

With reference now to FIG. 8, a block diagram illustrating one embodiment where parameter values are selected by a tree-based validation method is shown. This approach represents an improvement over traditional parameter validation methods, such as grid search 802 or random search, by emphasizing robustness over optimality in parameter selection.

In previous validation methods, all combinations of parameters in the model training pipeline are evaluated using a chosen metric, and the model with the best validation score is selected. While effective for identifying optimal parameter combinations, these methods often fail to account for robustness, especially when dealing with large datasets and complex feature spaces. For example, the selected parameters may provide the lowest Weighted Mean Absolute Percentage Error (WMAPE) score but lack stability when applied to new data due to proximity to outlier parameter combinations.

To address this limitation, the tree-based validation method 804 introduces an alternative approach that ensures robustness in parameter selection. The process begins by assigning validation scores 810 to all combinations of parameters from the forecast model. These validation scores, along with their corresponding parameter combinations, are used to train a tree-based model 804. In this model, the parameters (e.g., “Number of nearest neighbors” and “Similarity threshold”) form the features (806 and 808) of the tree and the validation scores (e.g., WMAPE values) serve as the target values (810). The tree-based model prioritizes features based on their importance, ensuring the most significant parameters are selected first.

Once the tree-based model is trained, the final set of parameters is selected by traversing down the decision tree 804. The traversal process begins at the root node 806 and proceeds through successive decision nodes. At each node, a greedy choice is made to move toward the leaf node with the highest mean payoff at that depth of the tree. This traversal strategy reduces the risk of selecting a leaf node that is adjacent to a bad outlier leaf node 812, thereby ensuring greater robustness in the selected parameters.

For example, in normal grid search 802 the combination of parameters yielding the lowest WMAPE score is selected. The “Number of nearest neighbors” parameter is chosen to be ≥5 (806), which is the less robust choice because it is adjacent to a bad score of 100. In contrast, when using the tree-based method 804 the “Number of nearest neighbors” parameter is selected based on the average payoffs at the decision node. The tree-based method selects<5 by comparing the left average score of 0.8 with the right average score of 50.3, thereby avoiding proximity to the bad outlier score. The traversal then continues to the “Similarity threshold” parameter, where the midway point (≥0.5) is selected based on similar comparisons (808). Finally, the validation score corresponding to these selected parameters (814) is used for model evaluation and deployment.

This approach provides several key advantages over traditional validation methods. The tree-based method is robust because it prioritizes mean payoffs and avoids proximity to outliers, so the selected parameters are more stable across varying datasets and scenarios. The tree-based method is also more efficient because it reduces the computational burden associated with exhaustive grid searches by leveraging the hierarchical structure of the decision tree. Further, the tree-based method is scalable and well-suited for large-scale datasets with numerous features, making it ideal for complex applications such as forecasting modeling.

In yet another embodiment, the hyperparameter selection process for the regression model employs a decision tree-based validation technique. Rather than relying on traditional grid or random search, which may select hyperparameters that are optimal on the validation set but unstable in practice, the decision tree approach evaluates all candidate parameter combinations and builds a tree where model hyperparameters serve as input features and the weighted mean absolute percentage error (WMAPE) values serve as targets. The tree is traversed in a greedy fashion, selecting branches at each node that yield the highest mean payoff, thereby avoiding proximity to outlier parameter values. This method ensures robust, stable hyperparameter selection and improves the generalizability of the trained regression model.

The decision tree-based validation process is particularly advantageous in complex feature spaces and large datasets, where exhaustive search methods may be infeasible. By prioritizing robustness over mere optimality, the system produces models that maintain high accuracy across varying operational conditions.

To ensure robust selection of hyperparameters for model training, the system implements a decision tree-based validation method. Rather than relying solely on grid or random search, which may identify hyperparameter combinations optimal for a specific validation set but unstable in practice, the decision tree approach evaluates all candidate parameter combinations (e.g., number of nearest neighbors, similarity threshold) and constructs a tree where model hyperparameters serve as input features and weighted mean absolute percentage error (WMAPE) values serve as targets. The tree is traversed in a greedy fashion, selecting branches at each node that yield the highest mean payoff, thereby avoiding proximity to outlier parameter values and improving generalizability. This method provides a principled mechanism for hyperparameter selection, prioritizing robustness across varying operational conditions and large, complex datasets.

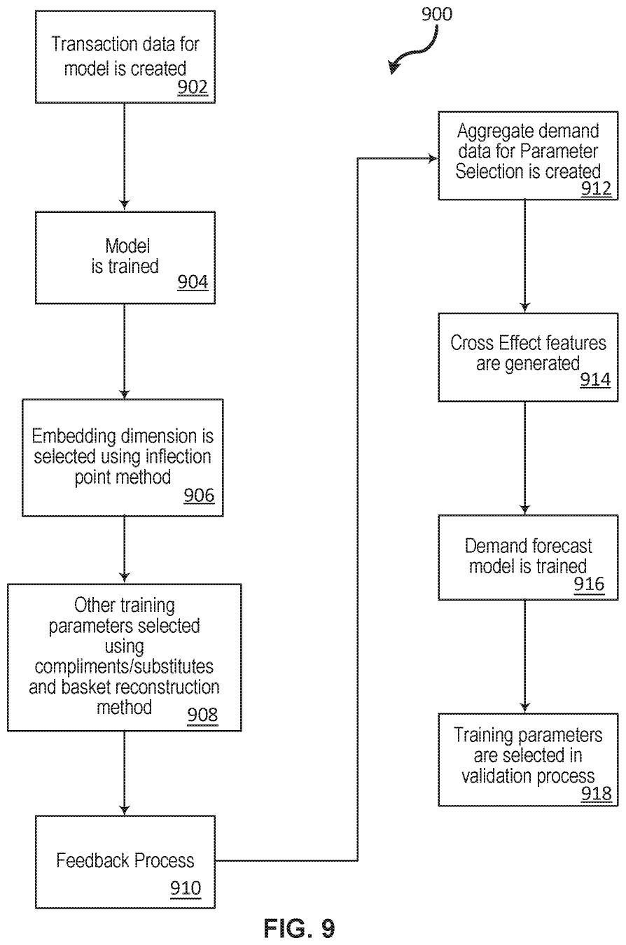

With reference now to FIG. 9, a flowchart illustrating one embodiment of the cross-effect estimation technique 900 is shown. The first part of the technique 902-910 concerns training an embedding space that all data elements are mapped into, including (1) a data preparation process 902 that creates pairs of data elements that occur or do not occur together based on the groups (2) a training process 904 that creates the embedding space, (3) a validation process 906 and/or 908 that determines a good set of parameters for the embedding space, and (4) a feedback process 910 that enhances the embedding space based on the desired use case. The second part of the technique 912-918 concerns cross effect estimation using the embedding space, including (1) creating the training data set from aggregated group data 912, (2) generating cross effect specific features 914, (3) training the forecasting model 916, and (4) validating the forecasting model 918. At the end, this framework identifies the relevant cross effect estimations for each data element.

Although the present disclosure focuses primarily on retail demand forecasting, the underlying techniques for cross-effect estimation and embedding space generation are broadly applicable to other domains. For example, the trained item embeddings and cross-effect features may be leveraged in inventory optimization, dynamic pricing and markdown strategies, and product recommendation engines. In each application, the ability to model substitute and complement relationships among items provides enhanced predictive power and decision support, allowing for improved operational efficiency and customer satisfaction.

While the present disclosure primarily focuses on demand forecasting, the techniques for cross-effect estimation and embedding space generation are broadly applicable to other domains within retail and beyond. For instance, the trained item embeddings and cross-effect features may be leveraged in inventory optimization, dynamic pricing and markdown strategies, assortment planning, and product recommendation engines. In these applications, the ability to model substitute and complement relationships among items provides enhanced predictive power and decision support, allowing for improved operational efficiency, customer satisfaction, and strategic decision-making. The modular nature of the embedding and feature generation processes enables seamless integration with various analytic frameworks, making the system versatile and extensible for a wide range of commercial uses.

The first part of the technique includes training the embedding space. This part of the technique creates a vector representation for each data element in an embedding space, enabling the classification of data element pairs based on their relationships. The first part of the technique may involve data preparation, an initial training of the embedding space, the generation of validation metrics, and refining the embedding space using the validation metrics.

First, pairs of data elements are generated based on group data (802). The training process of the embedding space relies on the creation of positive and negative samples derived from group data.

Positive samples are defined as pairs of data elements that occur together in the same group. For each group containing k data elements, all possible combinations of data element pairs are generated as positive samples, resulting in (k²) rows labeled with a positive value (label 1). For example, if data elements A, B, and C appear together in a group, the positive samples would include pairs (A, B), (B, C), and (A, C).

Negative samples, on the other hand, are formed by pairing a data element that appeared in the group with a data element that did not appear in the group. The negative sampling process employs an empirical distribution of all data elements across all groups, referred to as the unigram distribution, raised to the power of 0.75. This smoothing exponent overemphasizes data elements that occur in fewer groups and underemphasizes data elements that occur with higher group frequencies. For each group containing k data elements, j×k rows are generated as negative samples (label 0), where j is a configurable parameter representing the number of negative samples per data element (default value: j=1). Negative sampling ensures the representation of the entire group data and impacts the quality of the embedding space. This sampling approach ensures computational efficiency while capturing the complementary and substitution effects between data elements.

The embedding space is then trained. One such way of training the embedding space is using the “Item2Vec” algorithm (804). The new “Item2Vec” algorithmic framework can represent data elements as vectors in an n-dimensional embedding space. This is motivated from an established method called “Word2Vec” which is usually used within the domain of natural language processing (NLP) that can represent words in a vector space. Item2Vec iteratively moves data element pairs with positive labels closer together in the embedding space while distancing pairs with negative labels. This approach is computationally efficient and scalable, accommodating a large volume of data element pairs and groups.

Next, the dimension of the embedding space is selected using the inflection-point method outlined in FIG. 4 (906). When selecting a dimension for the embedding space, a tradeoff exists between large dimensions capturing complexities and small dimensions ensuring runtime efficiency; the dimension is chosen based on the distribution of pairwise dot products of data element vectors, aiming for a bell curve.

The embedding space can then be iteratively refined using a feedback loop designed to improve the quality of vector representations (908). This feedback process can include three distinct strategies such as group reconstruction scores, non-complement and non-substitute negative pairs, and/or substitute feedback.

The embedding space refinement process employs three distinct feedback mechanisms designed to iteratively improve model accuracy. First, the basket reconstruction feedback mechanism adjusts the weights of training samples based on the difficulty of reconstructing removed items from transaction baskets. If a positive sample (item pair that co-occurred) yields a low reconstruction score, its weight is increased in subsequent training iterations to emphasize its importance, whereas samples with high reconstruction scores are weighted less. This dynamic re-weighting ensures that the embedding space focuses on the most informative relationships.

Second, the substitute feedback mechanism introduces additional positive samples for item pairs identified as substitutes. Because substitutes rarely co-occur in transaction data, their presence as positive samples is underrepresented in conventional training sets. By explicitly adding substitute pairs as positive samples, the system ensures that substitute relationships are accurately captured in the embedding space, improving the model's ability to predict cross-effects.

Third, the non-complement/non-substitute feedback mechanism creates new negative samples for item pairs that are neither complements nor substitutes. These pairs are identified among the k-nearest neighbors of each item and are explicitly pushed apart in the embedding space by labeling them as negative samples. This strategy improves the discrimination power of the embedding space, ensuring that only meaningful relationships are encoded and that unrelated items are appropriately distanced.

Group reconstruction scores evaluate how well a data element removed from a group can be predicted based on the remaining data elements. For instance, given a group containing data elements A, B, and C, removing A requires predicting its presence using the vector representations of B and C. If the embedding space fails to reconstruct the group accurately, weights for the corresponding positive samples are increased to emphasize their importance in retraining. Conversely, if reconstruction succeeds, the weights are reduced. This ensures the embedding space accurately reflects relationships between data elements that appear together.

Additional negative samples can also be generated by identifying data element pairs that are neither complements nor substitutes. For example, if data elements A and B are unrelated, a negative sample labeled as 0 is created to push their vectors farther apart in the embedding space.

Also, substitute pairs can be specifically added as positive samples labeled as 1 to ensure their vectors are brought closer together, even though substitutes rarely appear together in the same group. For instance, if data elements A and B are substitutes, and both have a complement C, substitute feedback ensures A and B are positioned closer in the embedding space. These feedback mechanisms balance the weights of positive and negative samples while iteratively refining the embedding space for improved accuracy.

A value for the complement/substitute balance can also evaluate the percentage of complements and substitutes within the k-nearest neighbors of each data element, ensuring balance and adaptability to seasonal needs.

These validation metrics can then be used to guide improvements in the embedding space (810). Training samples can be selectively added or weighted based on the group reconstruction score and complement/substitute classification accuracy. Positive samples for substitutes can be added to account for pairs not directly derived from group data.

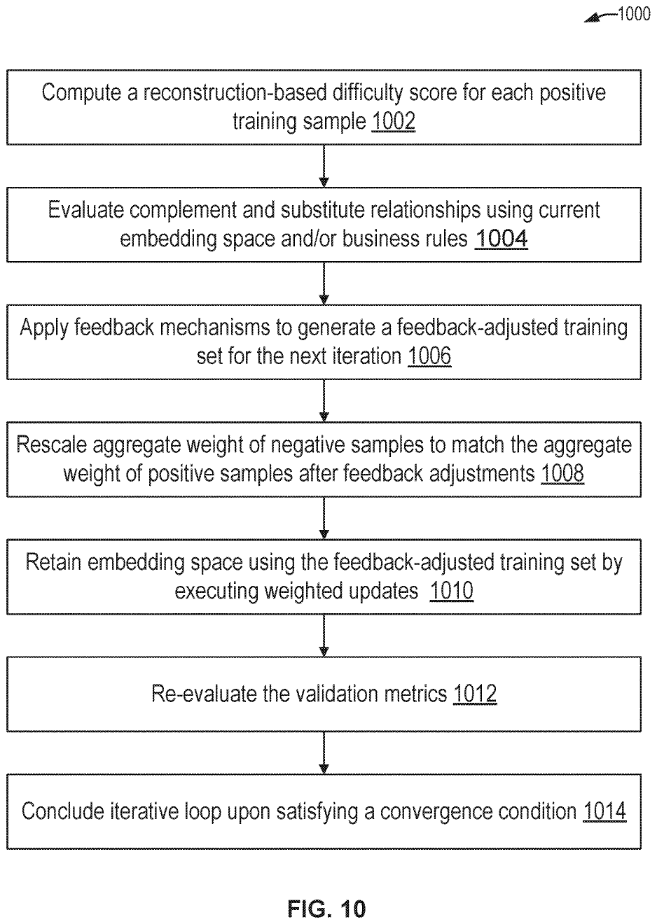

FIG. 10 illustrates a method 1000 for iterative feedback techniques, among other things. In some examples, the feedback-enhanced embedding training process begins at a computing device configured with one or more processors and memory storing executable code and data structures generated during initial Item2Vec training, including positive sample pairs derived from co-occurrence within groups, negative sample pairs sampled from a smoothed unigram distribution, and an initial embedding matrix whose vectors are normalized to a common norm for numerical stability.

In some examples, at block 1002, the method 1000 begins when the device computes a reconstruction-based difficulty score for each positive training sample by iteratively removing an item from each group, estimating the removed item from the remaining items using vector similarity in the embedding space, and recording the maximum similarity as a reconstruction score, and the device transforms this score into a difficulty value by applying a monotonic decreasing function so that harder-to-reconstruct positives obtain larger difficulty weights to influence subsequent training updates.

In some examples, at block 1004, the device then evaluates complement and substitute relationships using the current embedding space and business rules, computing a complement/substitute balance metric that measures the fraction of known complements and substitutes present among the k-nearest neighbors for each item, where k and the similarity cutoff are configurable to maintain interpretability and limit noise from weak relationships in the neighborhood graph.

In some examples, at block 1006, using the reconstruction-based difficulty and complement/substitute balance, the device applies three feedback mechanisms to generate a feedback-adjusted training set for the next iteration, where the device increases the weights of positive samples that are difficult to reconstruct while proportionally decreasing the weights of easy positive samples, augments the dataset with explicit positive samples for item pairs identified as substitutes to counteract underrepresentation due to their infrequent co-occurrence, and introduces additional negative samples labeled from item pairs identified as neither complements nor substitutes to improve discrimination in the embedding space between meaningful and incidental proximity relationships.

In some examples, at block 1008, to prevent bias between classes and encourage stable convergence, the device rescales the aggregate weight of all negative samples to match the aggregate weight of all positive samples after feedback adjustments, computing the total positive weight and applying a uniform scaling factor to negative sample weights so that the sum of negative weights equals the sum of positive weights before any retraining epoch begins, thereby maintaining statistical parity across iterations of the training loop and avoiding overemphasis on any one class as feedback proceeds.

In some examples, at block 1010, the device retrains the embedding space using the feedback-adjusted training set by executing weighted Item2Vec updates that move positive pairs closer and negative pairs further apart according to their current weights, with a learning rate schedule and early stopping criteria selected to respect computational constraints and to avoid overfitting to noisy pairs while the embedding distributions approach a target shape validated by the probability density function of pairwise dot products for a chosen dimension that exhibits exactly two inflection points indicative of a bell-shaped distribution with a distinct peak near unity for close relationships in the space.

In some examples, at block 1012, after each retraining epoch, the device re-evaluates the validation metrics, including reconstruction accuracy, complement/substitute balance, and the dot-product PDF inflection-point criterion, and persists the embedding version, training weights, and rules snapshot when improvements exceed configured thresholds while reverting to the previously persisted version when the new metrics degrade beyond tolerance bands to ensure robustness across volatile datasets and to support auditability of the evolution of the embedding space over time for later model governance and recalibration efforts.

In some examples, at block 1014, the iterative loop concludes upon satisfying a convergence condition defined as either the stabilization of validation metrics over a predetermined number of iterations, the attainment of a maximum number of feedback cycles, or the achievement of a minimum validation error improvement threshold, at which point the device normalizes the embedding vectors, serializes the trained space and associated metadata, and exposes the artifact to downstream cross-effect feature generation that multiplies inter-item similarity by the relevant variable associated with the influencing item to create cross-effect inputs for the forecasting models, subject to neighbor and similarity thresholds for efficiency and interpretability in subsequent training pipelines.

In some examples, the device optionally schedules periodic or event-driven refreshes of the embeddings by replaying the feedback loop with newly ingested group data, warm-starting from the last persisted embedding, and incorporating updated rules that reflect seasonal or regional changes in complement and substitute definitions, thereby keeping the representation aligned with evolving operational conditions and enabling dynamic updates to downstream cross-effect estimation without retraining costs associated with full pairwise modeling at scale.

The second part of the technique involves cross-effect estimation. This part of the technique integrates the cross-effect relationships into forecasting models. Steps in this portion of the technique may include preparing the training data, designing cross-effect features, training a forecasting model, and validating the forecasting model.

In some embodiments, aggregate data for parameter selection is then created (912). In some embodiments, group data is aggregated to create time series data for each data element. In additional embodiments, the baseline forecasting model accounts for seasonality, self-price effects, and holiday adjustments. In some embodiments, a rules engine enables data strategists to define complements and substitutes based on their specific business needs. These definitions can be tailored to account for seasonal variations, regional differences, and specific relationships between data elements. For example, a data strategist may define data elements A and B as substitutes during summer and B and C as complements during winter. The rules engine processes these definitions and adjusts the process of training the embedding space accordingly, ensuring flexibility and adaptability to dynamic environments.

In some embodiments, a configurable rules engine is integrated into the training pipeline to allow data strategists and retailers to define business-specific or seasonal relationships between items. The rules engine enables dynamic adjustment of complement and substitute definitions, accommodating variations such as regional preferences, seasonal trends, or promotional effects. This flexibility ensures that the embedding space and downstream demand model remain relevant and adaptive to changing business requirements, improving forecasting accuracy and operational responsiveness.

In some embodiments, the system incorporates a configurable rules engine that allows retailers and data strategists to dynamically adjust the definitions of complements and substitutes used during embedding space training. These rules can be tailored to account for seasonal trends, regional preferences, promotional effects, or other business-specific requirements. For example, an item pair may be defined as substitutes during summer but as complements during winter, or different thresholds for co-occurrence frequency may be set for different product categories. The rules engine processes these definitions and integrates them directly into the embedding space training pipeline, ensuring that the resulting vector representations and cross-effect features are aligned with current business objectives and market conditions. This adaptability provides users with the flexibility to refine model behavior over time and maintain forecasting accuracy as consumer behavior evolves.

At this point in the technique, cross-effect features are generated (914). Cross-effect features are designed to capture the influence of one data element's attributes on another data element's occurrences. In some embodiments, the similarity between data elements (derived from their vector representations) is multiplied by a value associated with one data element to create a feature for the forecasting model of the other data element. Simplifications reduce computational complexity, such as estimating a single coefficient for each data element to capture cross-effects on all other data elements and limiting features to the k-nearest neighbors with a similarity above a threshold. Complement and substitute effects can be differentiated by applying a multiplier of −1 to one of the effects.

Linear regression techniques can then train the forecasting model on the prepared dataset (916). Linear regression is a foundational statistical technique widely used in data analysis and predictive modeling. It establishes a relationship between a dependent variable and one or more independent variables by fitting a linear equation to the observed data. The simplest form, known as simple linear regression, involves a single independent variable, while multiple linear regression extends the approach to include two or more independent variables. The goal of linear regression is to minimize the difference between the observed values and the predicted values, typically by using the method of least squares to find the best-fitting line or plane.

Linear regression assumes a linear relationship between the dependent and independent variables, meaning that changes in the independent variables lead to proportional changes in the dependent variable. It is particularly useful for predicting outcomes, evaluating trends, and identifying the strength of relationships between variables. The model outputs coefficients that represent the impact of each independent variable on the dependent variable, allowing for interpretation and decision-making in various fields such as finance, healthcare, marketing, and engineering.

Here, the training process involves splitting the dataset into training and validation subsets. Regression techniques are applied to the training subset to fit the model parameters, while the validation subset is used to evaluate performance metrics such as Weighted Mean Absolute Percentage Error (WMAPE). Linear regression techniques that work well in cross-effect estimation technique 100 include Lasso and Ridge regression techniques.

Lasso regression, also known as Least Absolute Shrinkage and Selection Operator regression, is a linear modeling technique that incorporates an L1 regularization term in the objective function. Lasso regression is used to select the most critical features by eliminating irrelevant or weakly correlated variables. For example, it might exclude features associated with distant neighbors in the embedding space that have minimal influence on the target data element. The L1 regularization term shrinks coefficients toward zero, effectively performing feature selection by eliminating irrelevant or redundant features from the model. In the context of forecast modeling, Lasso regression is particularly useful for identifying the most significant features, such as cross-effect relationships, price elasticity, and seasonality factors, while excluding less relevant variables.

Ridge regression, also known as Tikhonov regularization, is a linear modeling technique that incorporates an L2 regularization term in the objective function. Ridge regression is used to handle scenarios where features are highly correlated, such as cross-effect features derived from similar data elements in the embedding space. By distributing weights across correlated features, Ridge regression ensures stability and avoids overfitting. The L2 regularization term prevents overfitting by shrinking the coefficients but does not eliminate features completely. Ridge regression is particularly useful in scenarios where features are highly collinear, ensuring stability in the model's predictions by distributing weights among correlated features.

In some embodiments, a hybrid approach combining Lasso and Ridge regression may be employed, referred to as Elastic Net regression. Elastic Net incorporates both L1 and L2 regularization terms, enabling simultaneous feature selection and weight distribution across correlated features. Elastic Net is particularly effective in scenarios where the dataset contains both sparse and highly correlated features.

These regression methods are employed to optimize the parameters of the forecast model, ensuring efficient feature selection and avoiding overfitting in scenarios involving complex datasets with numerous features. Parameters such as k-nearest neighbors, similarity thresholds, and regularization values can be optimized using validation data.

Optionally, a tree-based approach finally validates the forecasting model and selects optimal parameter values (918). Weighted Mean Absolute Percentage Error (WMAPE) can serve as the validation metric and is adaptable to business needs. A decision tree can ensure robust parameter selection by reducing the risk of outlier-induced errors.

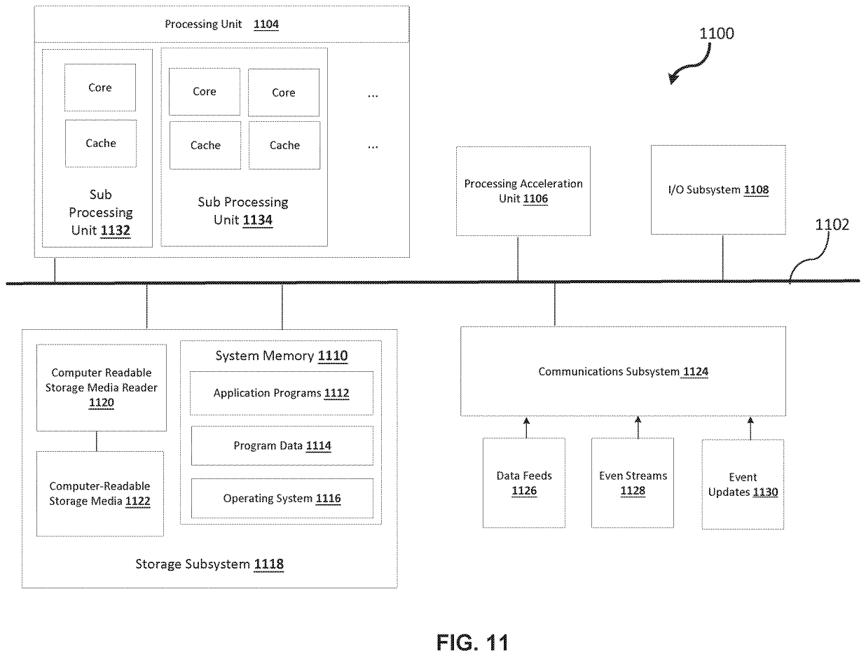

FIG. 11 illustrates an example computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that provides a tangible non-transitory computer-readable storage medium for storing software and data constructs that provide the functionality of the embodiments described in this disclosure. The software can include programs, code, instructions, scripts, etc., that when executed by one or more cores or processors of processing unit 1104 provide the functionality described above. Storage subsystem 1118 may also provide a repository for storing data used in accordance with the present disclosure.

As depicted in the example in FIG. 11, storage subsystem 1118 can include various components including a system memory 1110, computer-readable storage media 1122, and a computer readable storage media reader 1120. System memory 1110 may store program instructions that are loadable and executable by processing unit 1104. System memory 1110 may also store data that is used during the execution of the instructions and/or data that is generated during the execution of the program instructions. Various different kinds of programs may be loaded into system memory 1110 including but not limited to client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.). Different types of RAM configurations may be provided including a static random access memory (SRAM), a dynamic random access memory (DRAM), and others. In some implementations, system memory 1110 may include a basic input/output system (BIOS) containing basic routines that help to transfer information between elements within computer system 1100, such as during start-up.

Computer-readable storage media 1122 may represent remote, local, fixed, and/or removable storage devices plus storage media for temporarily and/or more permanently containing, storing, computer-readable information for use by computer system 1100 including instructions executable by processing unit 1104 of computer system 1100.

Computer-readable storage media 1122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM

(EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program services, and other data for computer system 1100.

Machine-readable instructions executable by one or more processors or cores of processing unit 1104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environment, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

### Example Process for Model Simplification:

In some examples, a method can receive a trained embedding space and baseline forecasting features. In some examples, the method can compute cosine similarities and select k-nearest neighbors above a similarity threshold for each item. In some examples, the method can classify each neighbor relationship as a complement or substitute using rules or co-occurrence patterns. In some examples, the method can encode each relationship as a signed effect that is positive for complements and negative for substitutes. In some examples, the method can construct one aggregate cross-effect signal per influencing item by combining the influencing variable with similarity and sign. In some examples, the method can assemble a design matrix with baseline features and one column per influencing item's aggregate signal. In some examples, the method can estimate a single coefficient per influencing item using regularized linear regression. In some examples, the method can validate the trained model using weighted mean absolute percentage error and robust parameter selection. In some examples, the method can serialize the trained model with its embedding snapshot and configuration for deterministic reproduction. Further, in some examples, the method can enforce sign constraints on per-item coefficients to align with complement and substitute classifications.

### Example Process for Iterative Feedback Mechanism:

In some examples, a method can initialize an embedding training state with positive samples, negative samples, and a normalized initial embedding space. In some examples, the method can compute a group reconstruction score for positive samples and derive a reconstruction difficulty weight. In some examples, a method can determine a complement/substitute balance using k-nearest neighbors subject to a similarity threshold in the embedding space. In some examples, the method can apply feedback by upweighting difficult positive samples based on reconstruction difficulty. In some examples, the method can augment the training set with explicit positive samples for substitute pairs. In some examples, the method can add negative samples for non-complement/non-substitute pairs to improve discrimination. In some examples, the method can rescale aggregate negative-sample weight to match aggregate positive-sample weight before retraining. In some examples, the method can retrain the embedding space with weighted Item2Vec updates and validate using reconstruction metrics and a pairwise dot-product PDF with two inflection points. In some examples, the method can persist or roll back the embedding version based on validation results and iterate until convergence conditions are met. In some examples, the method can serialize the trained embedding space and expose it for downstream cross-effect feature generation. Further, in some examples, the method can schedule periodic or event-driven refresh cycles that warm-start from a persisted embedding and re-execute the feedback loop.

What is claimed is:

1. A method, comprising:
generating, by a computing system, a plurality of vector representations of data elements from a plurality of groups organized based at least in part on relatedness of the pairs of data elements;
generating, by the computing system, an embedding space using the plurality of vector representations;
generating, by the computing system, one or more cross-effect features for each data element of a pair of data elements based at least in part on the embedding space;
selecting, by the computing system, a set of parameter values for a model based at least in part on the one or more cross-effect features;
training, by the computing system, the model based at least in part on the set of parameter values; and
providing, by the computing system, an output that identifies a relative cross-effect value for each data element of the pair of data elements according to the model.

2. The method of claim 1, wherein the one or more validation metrics include an embedding space dimension, a group reconstruction score, and a complement/substitute score.

3. The method of claim 2, wherein the value of the embedding space dimension is as small as possible while maintaining a probability density function with only two inflection points.

4. The method of claim 2, wherein the complement/substitute score is a percentage of substitute and complement pairs of data elements within a threshold number of neighbors of each of the plurality of vector representations within the embedding space.

5. The method of claim 2, wherein the group reconstruction score is a probability of determining a data element if the data element was removed from a group based on the remaining data elements in the group.

6. The method of claim 2, wherein the group reconstruction score is calculated by:
selecting a data element;
removing the data element from a first group; and
calculating similarity between the first group to a second group.

7. The method of claim 6, wherein the second group is selected based on proximity between the second group to the first group within the embedding space after the data element has been removed.

8. The method of claim 1, wherein generating the embedding space further comprises organizing the vector representations in the embedding space based upon a relationship between data elements.

9. The method of claim 1, wherein generating one or more cross-effect features for each data element of a pair of data elements is based at least in part on the similarity of the data elements within the embedding space.

10. The method of claim 1, wherein generating the one or more cross-effect features for each data element of a pair of data elements further comprises multiplying a similarity value of each pair of data elements with a numerical attribute associated with a data element from each pair of data elements.

11. The method of any preceding claim, wherein at least one of the set of parameter values for the model are selected using a tree-based validation method.

12. A computing system comprising:
one or more processors; and
one or more memories storing computer-executable instructions that, when executed by the one or more processors, configure the computing system to at least:
generate, by the computing system, a plurality of vector representations of data elements from a plurality of groups organized based at least in part on relatedness of the pairs of data elements;
generate, by the computing system, an embedding space using the plurality of vector representations;
generate, by the computing system, one or more cross-effect features for each data element of a pair of data elements based at least in part on the embedding space;
select, by the computing system, a set of parameter values for a model based at least in part on the one or more cross-effect features;
train, by the computing system, the model based at least in part on the set of parameter values; and
provide, by the computing system, an output that identifies a relative cross-effect value for each data element of the pair of data elements according to the model.

13. The computing system of claim 12, wherein the one or more validation metrics include an embedding space dimension, a group reconstruction score, and a complement/substitute score.

14. The computing system of claim 13, wherein the value of the embedding space dimension is as small as possible while maintaining a probability density function with only two inflection points.

15. The computing system of claim 13, wherein the complement/substitute score is a percentage of substitute and complement pairs of data elements within a threshold number of neighbors of each of the plurality of vector representations within the embedding space.

16. The computing system of claim 13, wherein the group reconstruction score is a probability of determining a data element if the data element was removed from a group based on the remaining data elements in the group.

17. The computing system of claim 13, wherein the group reconstruction score is calculated by:
selecting a data element;
removing the data element from a first group; and
calculating similarity between the first group to a second group.

18. A non-transitory computer-readable medium storing instructions that, when executed by one or more processors of a computing system, cause the computing system to perform operations comprising:
generating, by the computing system, a plurality of vector representations of data elements from a plurality of groups organized based at least in part on relatedness of the pairs of data elements;
generating, by the computing system, an embedding space using the plurality of vector representations;
generating, by the computing system, one or more cross-effect features for each data element of a pair of data elements based at least in part on the embedding space;
selecting, by the computing system, a set of parameter values for a model based at least in part on the one or more cross-effect features;
training, by the computing system, the model based at least in part on the set of parameter values; and
providing, by the computing system, an output that identifies a relative cross-effect value for each data element of the pair of data elements according to the model.

19. The non-transitory computer-readable medium of claim 18, wherein the one or more validation metrics include an embedding space dimension, a group reconstruction score, and a complement/substitute score.

20. The non-transitory computer-readable medium of claim 18, wherein the value of the embedding space dimension is as small as possible while maintaining a probability density function with only two inflection points.
